(19) United States
(12) Patent Application Publication
(10) Pub. No.: US 2026/0326952 A1
(43) Pub. Date: Oct. 22, 2026

(54) PROCESSING AND PALLETIZING UNIT FOR PACKAGED PRODUCTS

(71) Applicant: PLUSLINE S.R.L., Zola Predosa (IT)

(72) Inventors: Christian ZAGNONI, Valsamoggia (IT); Andrea CATALINI, Porcari (IT)

(73) Assignee: PLUSLINE S.R.L., Zola Predosa, BO (IT)

(21) Appl. No.: 19/117,457

(22) PCT Filed: Dec. 20, 2023
(86) PCT No.: PCT/IT2023/050290

§ 371 Date: Apr. 1, 2025

(30) Foreign Application Priority Data
Dec. 27, 2022 (IT) 102022000026880

(51) Int. Cl. B65B 35/50; B65B 5/06; B65B 25/14; B65B 35/36; B65G 47/90; B65G 57/24

(52) U.S. Cl. CPC B65B 35/50; B65B 5/067; B65B 25/146; B65B 35/36; B65G 47/902; B65G 57/24; B65G 2201/0238

(57) ABSTRACT

A processing and palletizing unit for packaged products including a first section for forming and possibly bagging product batches, and a second palletizing section, where, in the first section are arranged a device for forming batches, a bagging tunnel and a first manipulator that forms layers made up of bagged or unbagged batches oriented according to a pre-established order, and wherein in the second section a second manipulator is arranged for picking up the layers and positioning them on a pallet. The first manipulator includes one or more devices for picking up and handling bagged or unbagged batches, which devices are bounded to a structure arranged in a fixed position at the exit of the bagging tunnel in the first section.

### TECHNICAL FIELD

The present invention relates to a unit for processing and palletizing packaged products.

An operating unit in accordance with the present invention can be configured, for example, as a unit for the treatment and palletizing of packaged paper rolls, for example rolls of tissue paper.

### BACKGROUND

It is known that rolls of tissue paper, in particular rolls of toilet paper or kitchen paper or “kitchen towels” are generally packaged by making use of a packaging machine that produces packs or packages containing a pre-established number of rolls. The packages are transported to a bagging machine in which are formed batches, each consisting of a predetermined number of packages and in which the batches can be bagged to produce bags, each of which contains a predetermined number of packages. Downstream of the bagging machine there is generally a palletizing station in which robotic manipulators are installed which pick up the bags and arrange them on a pallet according to a predefined stratification order. The phase of bagging the packages can be avoided and, in this case, the batches pass through the bagging station of the machine without being bagged and form a layer of batches intended to be positioned on a pallet. A process of this type is described in EP1550610B1.

### SUMMARY

The main aim of the present invention is to propose a processing and palletizing unit for packaged products capable of carrying out the aforementioned operations in a particularly small space.

A further aim of the present invention is to propose a unit for the processing and palletizing of packaged products in which the system for forming the layers composed of batches of packages is integrated into the machine body of the bagging machine. This result has been achieved, in accordance with the present invention, by adopting the idea of realizing a processing and palletizing unit for packaged products having the features indicated in claim 1. Other features of the present invention are the subject of the dependent claims.

Thanks to the present invention, it is possible to reduce the overall dimensions and cost of the packaged products processing and palletizing units, ensuring high operational flexibility to manage the packaging and palletizing of the items according to modes that are programmable by the user. Furthermore, the construction simplicity of a processing and palletizing unit in accordance with the present invention is highlighted.

### BRIEF DESCRIPTION OF THE DRAWINGS

These and further advantages and characteristics of the present invention will be more and better understood by every person skilled in the art thanks to the following description and the attached drawings, provided by way of example but not to be understood in a limiting sense, in which:

FIG. 1A represents a schematic top view of a unit for processing and palletizing of rolled articles, in particular rolls of tissue paper, in accordance with the present invention;

FIG. 1B represents by way of example a batch of two packs of rolled items;

FIG. 1C is a schematic side view of the unit of FIG. 1A in which some parts are not represented to better highlight others;

FIG. 2A is a perspective view of the unit of FIG. 1C in correspondence with the welding tunnel;

FIG. 2B is a diagram representing the possible adjustments of the lateral containment guides of the batches arranged on the elevator;

FIGS. 3A-3C represent a double manipulator comprising two independent grippers;

FIGS. 4A-4D represent a possible embodiment of a gripper of the manipulator shown in FIGS. 3A-3C in a perspective view (FIG. 4A), a top view from below (FIG. 4B), a bottom (FIG. 4C) and a sectional view along the line H-H of FIG. 4C (FIG. 4D);

FIGS. 5A-5B schematically represent two different layers of batches;

FIG. 6 represents a single manipulator.

### DETAILED DESCRIPTION OF EMBODIMENTS

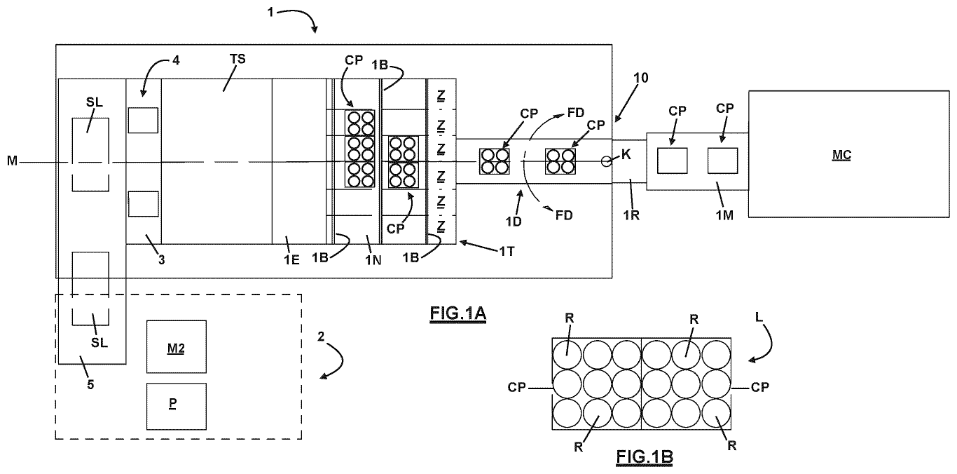

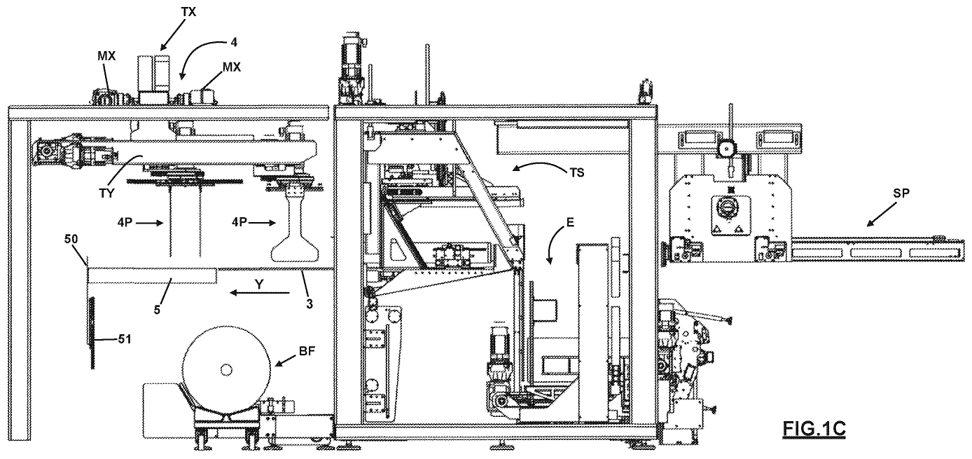

Reduced to its essential structure and with reference to the attached exemplary drawings, a processing and palletizing unit for rolled articles in accordance with the present invention comprises a batching and bagging section (1) and a palletizing section (2). The batch formation and bagging section (1) has an entry station (10) that receives the packages (CP) of paper rolls produced by a packaging machine arranged upstream. The packaging machine is a machine known to those skilled in the art and is therefore not described in greater detail. In the illustrative diagram of FIG. 1A the packaging machine is indicated schematically by the block “MC”. Each package (CP) is made up of a predetermined number of rolls of paper (R) arranged on a single layer or on multiple layers, wrapped in a wrapping sheet which, for example, is made of a film of plastic material.

Between the packaging machine (MC) and said inlet station (10) is arranged a corresponding conveyor (IM).

The packaging machine (MC) arranges the packages (CP) horizontally on the conveyor (IM), i.e. with the axes of the paper rolls arranged horizontally.

In the inlet station (10) there is a tilting device (1R) that, in known ways, overturns the packages (CP), placing them in a vertical position, i.e. with the axes of the paper rolls oriented vertically.

The tilting device (1R) delivers the packages (CP) to a diverter (ID) which, in cooperation with a suitable conveyor (IT), commonly called indexing conveyor, arranged downstream of the same diverter with respect to the direction of origin of the packages (CP), forms batches (L) each of which is made up of a pre-established number of packages (CP) placed side by side. In the illustrative diagram of FIG. 1B, a batch (L) is made up of two packages (CP) each containing four rolls (R). It is understood, however, that the number of packages that form the batches and the number of rolls of each package may be different from what has been exemplified. For example, a batch (L) could also consist of a single package (CP) and a package (CP) could also contain a single roll (R).

The indexing conveyor (IT) comprises a conveyor belt (IN) and a series of bar-shaped pushers (IB) oriented transversally to the conveyor belt. With known methods, the diverter (ID), rotating around a vertical axis (Y) as schematically indicated by the arrows “FD” in FIG. 1A, places each package (CP) on a corresponding area (Z) of the indexing conveyor (IT) and the latter, thanks to the coordinated movement of the belt (IN) and the pushers (IB), transports the packages (CP) to an elevator (IE) on which, finally, the individual batches are arranged. The elevator (E) has a plane (PE) which receives the packages making up the individual batches and raises the batches to a height corresponding to the entrance of a tunnel (TS) in which means are arranged and acting to wrap the batches in a bag of plastic material and to seal the bag itself at the end of the bagging process. In practice, the plane (PE) is positioned at the height of the tunnel (TS), then a pusher (SP) pushes the batch inside the tunnel (TS). The batches are bagged using methods known to the technicians of this field. In practice, to carry out the bagging, is used a film of plastic material fed by a reel (BF) placed underneath the tunnel (TS) to produce a tube that, following the entry of the products into the tunnel determined by the pusher (SP), is welded along the sides and at the tail side. A process of this type is described in EP1801012B1.

The coordinated intervention of the diverter (ID) and the indexing conveyor (IT) determines the formation of individual batches (L) according to the scheduled production. It goes without saying that the operation of the operative units described above is controlled by a programmable control unit in which the programmed production data are entered or stored. The operation and structure of the packaging machine (MC), the tilting device (1R), the diverter (ID), the indexing conveyor (IT), the elevator (E), the pusher (SP) and the bagging tunnel (TS) are known to those skilled in the art.

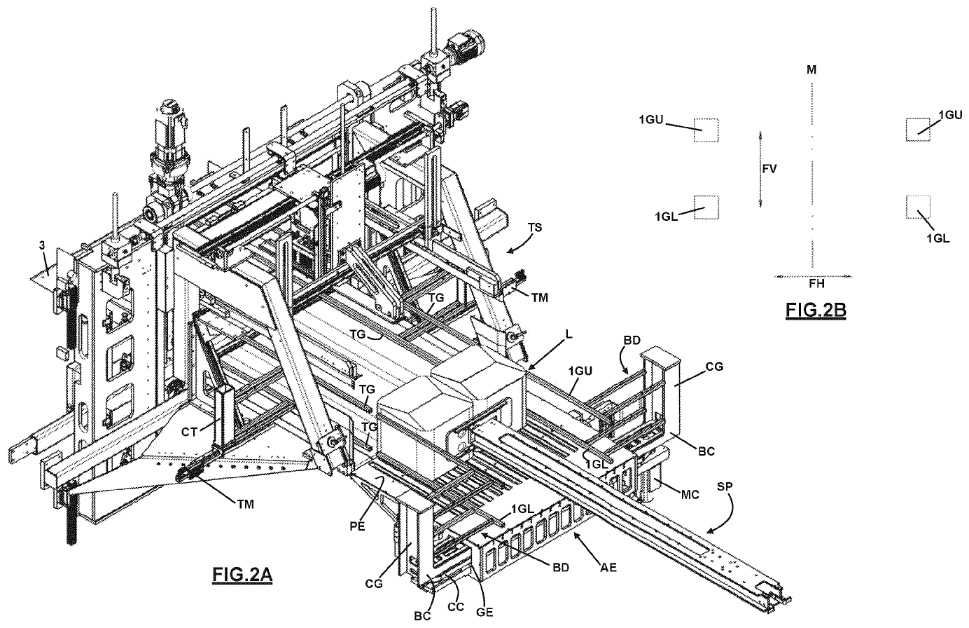

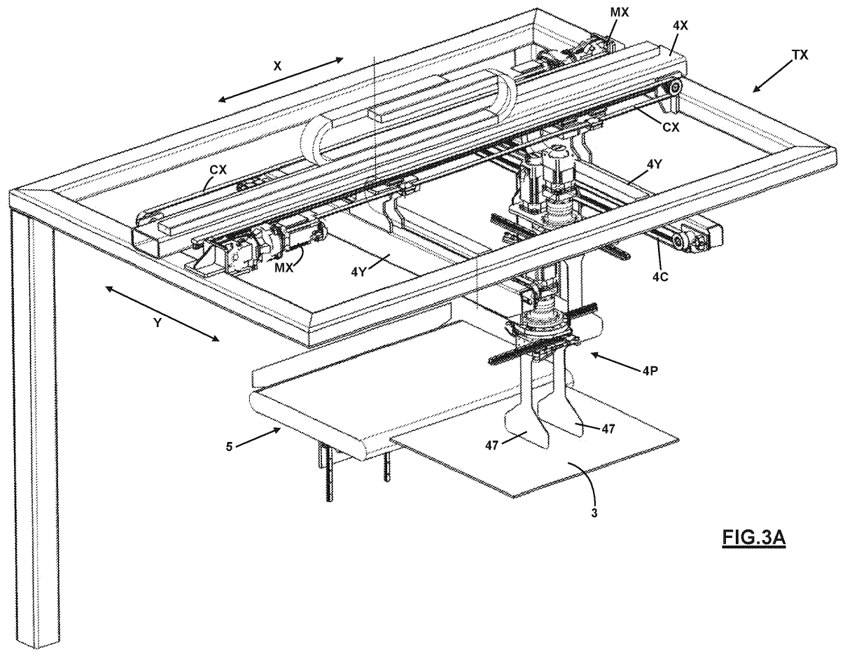

Preferably, in accordance with the present invention, on the elevator (E) are mounted two lateral containment guides (1GL, 1GU) that can be positioned symmetrically with respect to the center line (M) of section (1), which delimit on two opposite sides the space occupied by the packages (CP) on the elevator. In practice, the guides (1GL, 1GU) delimit the right side and the left side of the aforementioned space and their mutual position, i.e. their position with respect to the center line (M) of the section (1), is adjusted according to the number and of the dimensions of the packages that make up each batch. In this way, before being pushed into the tunnel of the bagging station, the packages of the batch will be compacted. With reference to the embodiment represented in FIG. 2A, on the front side (AE) of the plane (PE), i.e. on the side facing the pusher (SP), two columns (CG) are mounted, each of which has a horizontal base (BC) slidably inserted into a guide cavity (GE) formed on the same front side (AE). The bases (BC) are bound to a belt (CC) driven by an electric motor (MC) which, in this way, determines the simultaneous mutual approach and spacing of the columns (CG), i.e. the simultaneous approach and spacing of the columns (CG) at the center line (M) of the section (1). On each column (CG) two horizontal bars are mounted longitudinally oriented with respect to the plane (PE), which bars constitute the aforementioned guides (1GL, 1GU). Said bars are applied to the columns (CG) by means of respective transverse spacer arms (BD) and form two pairs of bars in which each pair comprises a lower bar (1GL) and an upper bar (1GU). Preferably, the lower bars (1GL) are fixed to the columns (CG) by means of the respective spacers (BD) at a pre-established distance from the plane (PE), while the upper bars (1GU) are preferably connected removably to the columns (CG) in order to adjust the distance from the lower ones. Therefore, as represented in the diagram of FIG. 2B, the position of the bars (1GL, 1GU) with respect to the center line (M) can be adjusted according to the width and height of the batch (L) as schematically indicated by the arrows (FH, PV).

For example, the arms (BD) of the upper bars (1GU) can be fixed to the columns (CG) with screw means that allow them to be repositioned at the desired height.

Depending on the scheduled work program, the batches (L) can be bagged, i.e. packaged in a bag of plastic material, or they can pass through the bagging tunnel (TS) without being bagged.

Preferably, longitudinal guides (TG) are arranged in the bagging tunnel (TS) which, similarly to what is provided on the elevator (E), constitute a lateral containment system for the batches within the same tunnel (TS) realized in such a way such that the batches (L) are correctly centered with respect to the center line (M). The guides (TG) of the tunnel (TS) can be made similarly to the guides (1GU, 1GL) provided on the elevator (E). For example, the guides (TG) can be made up of two pairs of bars arranged longitudinally with respect to the tunnel (TS) and connected to respective columns (CT) which can be moved to and from the center line (M) by means of electric actuators (TM). Also in this case, the lower bars can be fixed at a fixed height to the respective columns (CT) and the upper bars can be removably connected to the same columns in order to provide a containment and centering system for the batches in the tunnel (TS) similar to the one provided on the elevator (E), allowing the mutual distance of the guides (TG) and their overall height to be adjusted according to the dimensions and height of the individual batches (L).

If not bagged, the batches (L) are pushed, by the pusher (SP), onto the surface (3) provided immediately downstream of the bagging tunnel (TS) with respect to the direction (Y) from which the batches come. If, however, the batches (L) are bagged, the bags containing the batches are already on said plane (3) when the bags are formed. When the batches (L) are bagged, the guides (TG) are removed so as not to interfere with the bagging operation. The plane (3) is a horizontal plane that serves as a temporary storage for the batches (L) or the bags.

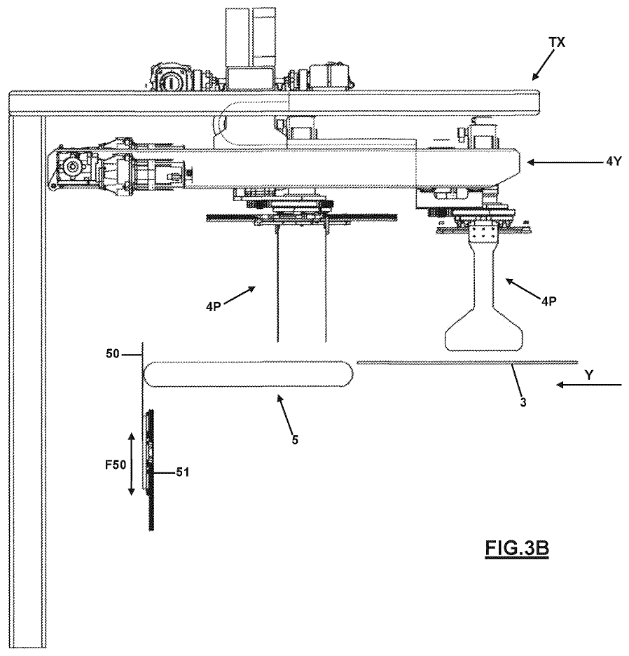

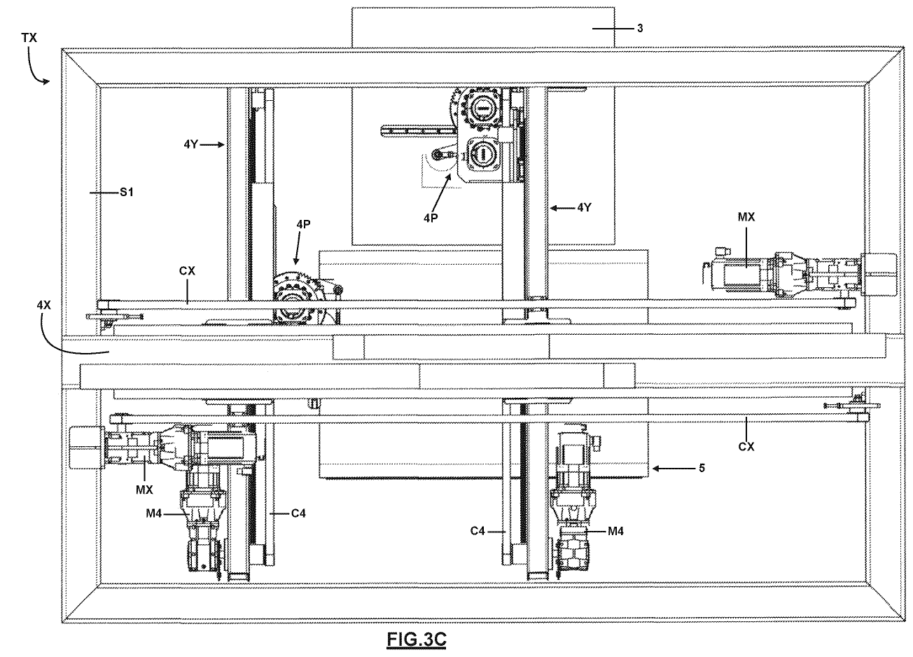

Above the plane (3) there is a programmable manipulator (4) which is used to pick up the batches (L) from the tunnel (TS) exit plane (3) and, as further described below, is used to form layers (LS) of batches in which layers each batch (L) has a predefined orientation depending on the scheduled production. Therefore, layers (SL) are formed immediately downstream of the bagging tunnel (TS). With reference to the example represented in FIGS. 3A-3B, the programmable manipulator (4) is made up of a pair of independent grippers (4P) which can both be moved along two orthogonal directions (Y, X). Each gripper (4P) comprises two jaws (G4) whose opening and closing movement is controlled according to the size of the batches from time to time positioned on the plane (3). With reference to the examples shown in the attached drawings, each gripper (4P) is constrained to a corresponding beam (4Y) oriented parallel to the direction (Y) of origin of the batches (L) exiting the bagging tunnel (TS), each gripper (4P) being connected to a belt (C4) driven by a respective gearmotor (M4) which controls its movement parallel to the beam (4Y). Said beams (4Y) are constrained, in turn, to a third beam (4X) fixed to the structure (SI) and oriented along the direction (X) orthogonal to the direction (Y) of origin of the batches (L), each beam (4Y) being connected to a belt (CX) driven by a respective gearmotor (MX) which controls its movement parallel to the beam (4X). Therefore, each gripper (4P) can be moved along both directions (X, Y) independently of the other gripper. In other words, each gripper (4P) can be translated along the (X) and (Y) directions independently of the translations of the other gripper along these directions.

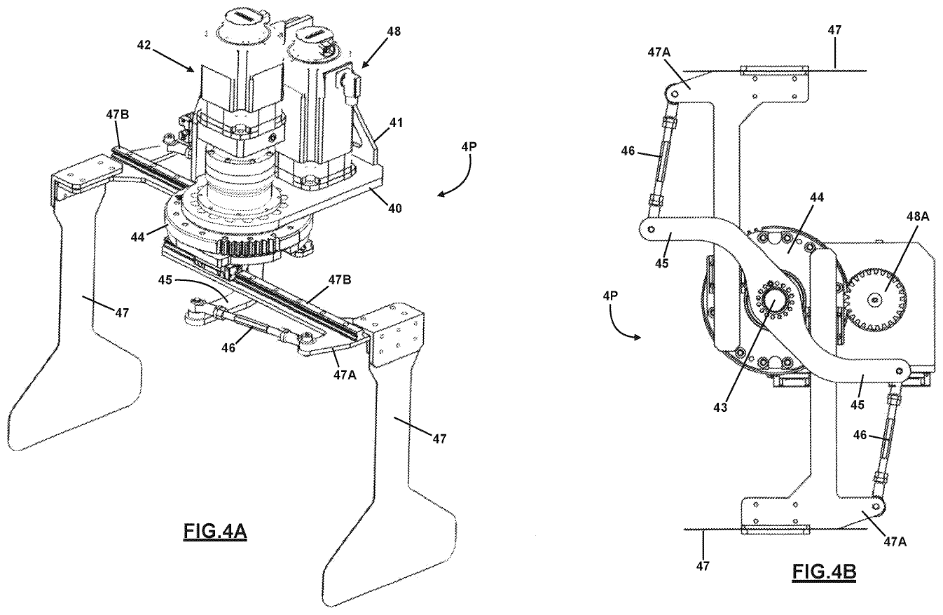

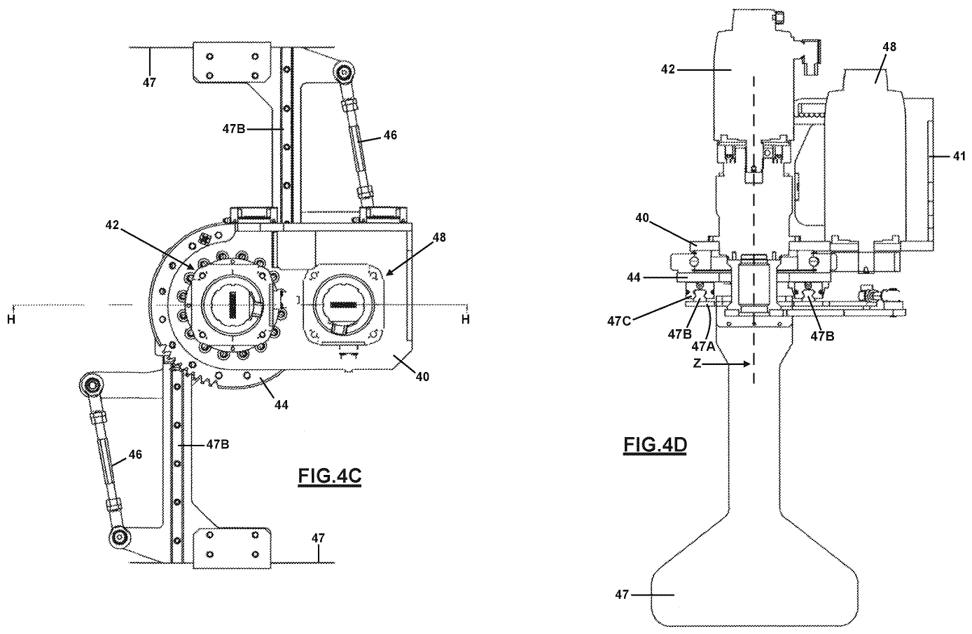

With reference to the example represented in FIGS. 4A-4B, each gripper (4P) comprises a base plate (40) with a rear orthogonal appendage (41) through which the gripper is connected to the respective belt (4C). On the upper side of the plate (40) a first electric motor (42) is mounted whose shaft (43) passes through a toothed slewing ring wheel (44) with external teeth that is mounted on the lower side of the plate (40). The toothed slewing ring (44) is parallel to the plate (40) and has a rotation axis (Z) orthogonal to the same plate. On the end of the shaft (43) of the motor (42) is mounted a lever with two arms (45) in diametrically opposite positions. On the distal end of each arm (45) is mounted a rod (46) that, on the opposite side, is mounted on an appendix (47 A) of a linear guide (47B) on which a respective jaw (47) is mounted. Each guide (47B) is inserted into a corresponding skid (47C) formed on the lower side of the toothed slewing ring (44). The latter is engaged, with its external teeth, with a pinion (48A) driven by a second electric motor (48) whose shaft passes through the plate (40) and is connected to the pinion (48A) which is also on the lower side of the plate (40). Therefore, the motor (42) controls the opening and closing, i.e. the mutual distancing and approaching, of the jaws (47) along the direction of the guides (47B), while the motor (48) controls the rotation of the toothed slewing ring (44), and consequently of the jaws (47), around the aforementioned axis (Z).

Preferably, said jaws (47) are formed by shaped plates of relatively reduced thickness. Ultimately, each gripper (4P) can be moved along the (X) and (Y) directions and can rotate around the axis (Z) and the jaws (47) of each gripper (4P) can be reciprocally distanced and approached to each other. All the aforementioned actuators are controlled by the programmable control unit in which the programmed production data are entered or stored.

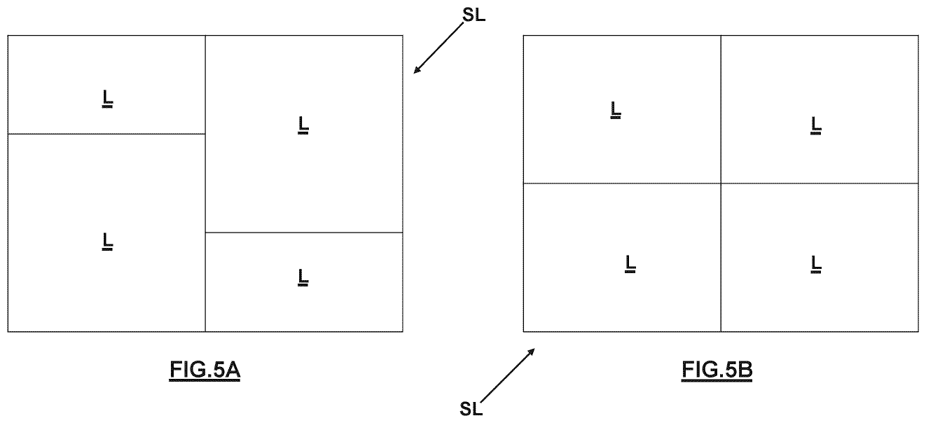

Each gripper (4P) picks up a batch (L) from the plane (3) and places it, oriented along a programmed direction (i.e. moving it parallel to itself or rotating by 90° clockwise or anticlockwise or by 180°), releasing it on a surface (5) arranged downstream of the plane (3) with respect to the direction of origin of the batches (L). The surface (5) is the upper surface of a conveyor on which the layers (SL) of batches to be palletized are formed. Each layer is composed of a predefined number of batches (L) each of which is oriented according to a pre-established orientation. As a non-limiting example, two possible layers (SL) are represented in FIGS. 5A and 5B. The batches (L) that make up the layer (SL) can be identical to each other or even different. During the formation of a layer (SL) the conveyor (5) can be stationary or moving with a speed commensurate with the speed of the grippers (4P).

Preferably, a barrier (50) is positioned behind the conveyor (5) which prevents the batches (L) from falling beyond the conveyor itself. Preferably, said barrier (50) is mounted on a structure (51) arranged below the conveyor (5) and can be adjusted in height as schematically indicated by the arrow (F50).

When a layer (SL) has been formed, the conveyor (5) transports the layer to the palletizing section (2) where a second manipulator (M2) is arranged and acting which picks up the layer (SL) and places it on a pallet. This last operation can be performed with means and methods known to those skilled in the art and is therefore not described in greater detail.

The layers can also be made up of bags containing the batches (L) if the bagging of the latter has been foreseen.

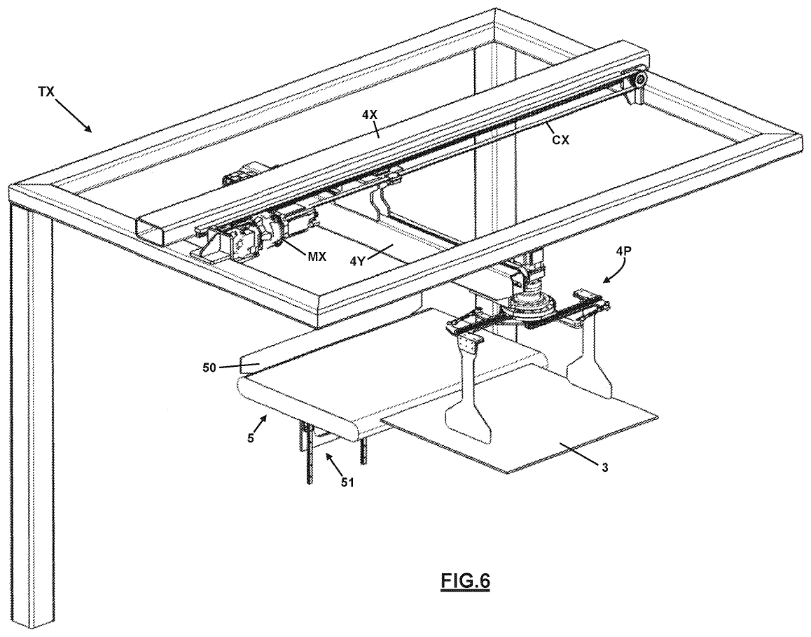

The use of a double manipulator, comprising two independent devices (4P) for picking up and handling the batches (L), allows these units (4P) to be moved with little acceleration and deceleration, reducing the risk of damaging the batches in the phase of formation of the layers (SL). However, it is possible to use a manipulator with a single device (4P) for picking and handling the batches (L) as shown by way of example in FIG. 6.

With reference to the examples represented in the drawings, the beam (4X) of the structure to which the devices (4P) for picking and handling the batches (L) are attached is in a fixed position and intercepts the center line (M) of the machine. In other words, the manipulator is made up of one or more devices (4P) linked to a structure arranged in a fixed position at the exit of the bagging tunnel (TS).

As previously mentioned, the structure (TX) to which the devices (4P) are attached is advantageously positioned immediately downstream of the bagging tunnel (TS) and, therefore, the layers (SL) are formed immediately downstream of the bagging tunnel (TS), then they are transferred to the palletizing section (2) where the second manipulator (M2) is located. In practice, in accordance with the present invention the first manipulator (4) is integrated into the section (1) for forming the batches (L) so that the layers (SL) are already formed in the same section (1) before being conveyed to the palletizing section (2).

Although the foregoing description refers to rolled items such as rolls of tissue paper, the present invention also extends to the handling and palletizing of non-rolled items. For example, the packages (CP) could be made up of a pre-established number of packs of handkerchiefs or tissue paper napkins intended to be bagged. In this case, as previously described, the layers (SL) are made up of packs of bagged handkerchiefs or paper napkins. More generally, the packages (CP) can contain other types of articles for which palletization is envisaged with the formation of layers (SL) consisting of a pre-established number of bagged or non-bagged batches (L).

From the previous description it is evident that a processing and palletizing unit for packaged products in accordance with the present invention comprises a first section.

(1) for forming and possibly bagging product batches and a second palletizing section

(2), wherein in the first section (1) are arranged a device for forming batches (L) each formed by a predetermined number of packages (CP) containing a predetermined number of items, a bagging tunnel (TS) in which the batches (L) can be bagged and a first manipulator (4) comprising means for picking and handling both bagged and unbagged batches (L), wherein the first manipulator (4) forms layers (SL) made up of bagged or unbagged batches (L) oriented according to a pre-established order, wherein in the second section (2) a second manipulator (M2) is arranged for picking up the layers (SL) and positioning them on a pallet (P), and wherein the first manipulator (4) comprises one or more devices (4P) for picking up and handling bagged or unbagged batches (L), which devices (4P) are bounded to a structure (TX) arranged in a fixed position at the exit of the bagging tunnel (TS) in said first section (1) for forming the batches.

Moreover, a processing and palletizing unit for packaged products in accordance with the present invention may exhibit one or more of the following features, even combined with each other: the structure (TX) to which the devices (4P) for picking up and handling the bagged or unbagged lots (L) are connected is a beam oriented along an exit direction (Y) of the bagged or unbagged lots (L) from the bagging tunnel (TS). The first manipulator (4) comprises a single device (4P) for picking up and handling the bagged or unbagged batches (L). The first manipulator (4) comprises two independent devices (4P) for picking up and handling the bagged or unbagged batches (L). The device for forming the batches (L) in the first section (1) comprises an elevator (E) on which are arranged guides (1GL, 1GU) adjustable in width and preferably also in height and intended to delimit on two opposite sides a space for the batches (L) that is centered with respect to a centerline (M) of the processing and palletizing unit guides (TG) adjustable in width and preferably also in height are provided in the bagging tunnel (TS) and intended to delimit on two opposite sides a space for the batches (L) that is centered with respect to a center line (M) of the processing and palletizing unit, each device (4P) for picking up and handling the batches (L) comprises a two-jaw gripper (47) with a first actuator (42) which controls the opening and closing of the jaws and a second actuator (48) which controls the rotation of the gripper around a respective axis of rotation (Z).

In practice, the execution details can however vary in an equivalent way as regards the individual elements described and illustrated, without thereby departing from the scope of the following claims.

1-7. (canceled)

8. A processing and palletizing unit for packaged products, comprising: a first section for forming and bagging product batches and a second palletizing section, wherein, in the first section, there are arranged a device for forming batches each formed by a predetermined number of packages containing a predetermined number of items, a bagging tunnel in which the batches can be bagged and a first manipulator comprising means for picking and handling both bagged and unbagged batches, wherein the first manipulator forms layers are made up of bagged or unbagged batches oriented according to a pre-established order, wherein in the second section a second manipulator is arranged for picking up the layers and positioning them on a pallet, wherein the first manipulator comprises one or more devices for picking up and handling bagged or unbagged batches, which devices are bounded to a structure arranged in a fixed position at the exit of the bagging tunnel in said first section for forming the batches.

9. The processing and palletizing unit for packaged products according to claim 8, wherein the structure to which the devices for picking up and handling the bagged or unbagged batches are connected is a beam oriented along an exit direction of the bagged or unbagged lots from the bagging tunnel.

10. The processing and palletizing unit for packaged products according to claim 8, wherein the first manipulator comprises a single device for picking up and handling the bagged or unbagged batches.

11. The processing and palletizing unit for packaged products according to claim 8, wherein the first manipulator comprises two independent devices for picking up and handling the bagged or unbagged lots.

12. The processing and palletizing unit for packaged products according to claim 8, wherein the device for forming the batches in the first section comprises an elevator on which are arranged guides adjustable in width and is configured to delimit, on two opposite sides, a space for the batches that is centered with respect to a centerline of the processing and palletizing unit.

13. The processing and palletizing unit for packaged products according to claim 8, wherein guides adjustable in width are provided in the bagging tunnel and configured to delimit, on two opposite sides, a space for the batches that is centered with respect to a center line of the processing and palletizing unit.

14. The processing and palletizing unit for packaged products according to claim 8, wherein each device for picking up and handling the batches comprises a two-jaw gripper with a first actuator which controls the opening and closing of the jaws and a second actuator which controls the rotation of the gripper around a respective axis of rotation.
